(19) United States
(12) Patent Application Publication
(10) Pub. No.: US 2012/0229644 A1
(43) Pub. Date: Sep. 13, 2012

(54) EDGE POINT EXTRACTING APPARATUS AND LANE DETECTION APPARATUS

(75) Inventors: Shunsuke Suzuki, Nukata-gun (JP); Kazuhisa Ishimaru, Nagoya (JP)

(73) Assignees: Nippon Soken, Inc., Nishio-city (JP); DENSO CORPORATION, Kariya-city (JP)

(21) Appl. No.: 13/415,253

(22) Filed: Mar. 8, 2012

(30) Foreign Application Priority Data
Mar. 10, 2011 (JP) 2011-053143

(51) Int. Cl. G06K 9/46; H04N 7/18

(52) U.S. Cl. 348/148; 382/104; 348/E07.085

(57) ABSTRACT

An edge point extracting apparatus is provided which includes an image obtaining unit which obtains a road surface image which is picked up from a road surface ahead of a vehicle and from which a plurality of color components are separately extracted a high luminance component selecting unit which extracts a pixel group including a plurality of pixels arranged in a line on the road surface image and selects a color component from the plurality of color components in the pixel group, the selected color component having the highest average luminance which is equal to or more than a predetermined threshold and an edge extracting unit which extracts an edge point in the pixel group by using a color component of the plurality of color components other than the color component selected by the high luminance component selecting unit.

### CROSS-REFERENCE TO RELATED APPLICATION

This application is based on and claims the benefit of priority from earlier Japanese Patent Application No. 2011-053143 filed Mar. 10, 2011, the description of which is incorporated herein by reference.

### BACKGROUND OF THE INVENTION

1. Technical Field of the Invention

The present invention relates to a lane detection apparatus that detects a lane based on an image picked up from the road surface ahead of the vehicle which is equipped with the lane detection apparatus.

2. Related Art

Lane detection apparatuses are well known. Such a lane detection apparatus captures an image from the road surface ahead of the vehicle equipped with the apparatus and processes the image to detect a lane. The term lane here refers to a region on a road, which is defined between lines such as of painted markers, e.g. solid or broken white or colored lines, or raised markers intermittently arranged along the traveling direction of the vehicle.

In detecting a lane, some lane detection apparatuses capture a road surface image, extract an edge point from the image at which the luminance changes due to the presence of the painted markers, the raised markers or the like, and detect a lane based on a plurality of such extracted edge points. The information on the lane detected by such a lane detection apparatus is combined with vehicle behavior information, such as traveling direction, traveling speed and steering angle, for use in predicting whether or not the vehicle has a risk of deviating from the lane, or for use as a piece of information in performing automatic steering angle control.

However, depending on the color of the painted markers and the ambient brightness, only a low contrast may be exhibited between the lane line and the road in a road surface image captured by the apparatus. The low contrast may lower the accuracy of extracting an edge point and thus may make the lane recognition difficult.

To take measures against this, an on-vehicle image-processing camera system has been developed as disclosed in a patent document JP-2003-032669. This camera system independently obtains an image of a road surface in the form of three-color signals and obtains a combination of the color signals, which maximizes the contrast between the road surface and a lane line to thereby perform lane recognition processing using the combination. Of the three-color signals, this system uses the red and green components, for example, to compose a yellow image. Use of the yellow image enhances the accuracy of detecting the lane defined by yellow lines.

In the camera system disclosed in the patent document JP-2003-032669, an optimal color-signal combination is found by composing an image for each of the plurality of color-signal combinations and determining a color-signal combination that maximizes the contrast. However, such a way of processing increases the processing load of the camera system and thus tends to raise a problem of causing delay in the processing, or a problem of increasing cost due to the need of a high-performance processor.

### SUMMARY

An embodiment provides an edge point extracting apparatus which can suppress the increase of the processing load and well extract an edge point, and to provide a lane detection apparatus.

As an aspect of the embodiment, an edge point extracting apparatus is provided which includes: an image obtaining unit which obtains a road surface image which is picked up from a road surface ahead of a vehicle and from which a plurality of color components are separately extracted; a high luminance component selecting unit which extracts a pixel group including a plurality of pixels arranged in a line on the road surface image and selects a color component from the plurality of color components in the pixel group, the selected color component having the highest average luminance which is equal to or more than a predetermined threshold; and an edge extracting unit which extracts an edge point in the pixel group by using a color component of the plurality of color components other than the color component selected by the high luminance component selecting unit.

### BRIEF DESCRIPTION OF THE DRAWINGS

In the accompanying drawings:

FIG. 1 is a block diagram illustrating a lane deviation warning system according to an embodiment of the present invention;

FIG. 2 is a flow diagram illustrating a lane deviation warning processing performed in the system by an image processing ECU;

FIG. 3 shows an example of a road surface image picked up by a camera in the system, and superimposed luminance graphs;

FIGS. 4A and 4B each show a road surface image and a superimposed luminance graph resulting from luminance conversion conducted in the system based on three-color and two-color components, respectively;

FIG. 5 shows an example of a road surface image picked up by the camera in the system, and superimposed luminance graphs;

FIGS. 6A and 6B show partially enlarged luminance graphs of FIG. 5; and

FIGS. 7A and 7B each show a road surface image and a superimposed luminance graph resulting from luminance conversion conducted in the system based on three-color and two-color components, respectively.

### DETAILED DESCRIPTION OF THE PREFERRED EMBODIMENTS

With reference to the accompanying drawings, hereinafter is described an embodiment to which an edge extracting apparatus and a lane detection apparatus of the present invention are applied.

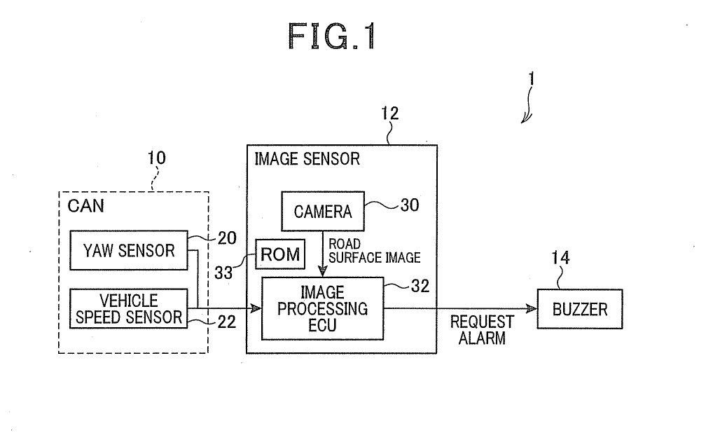

FIG. 1 is a block diagram illustrating a lane deviation warning system 1 according to the embodiment. The lane deviation warning system 1 is used being installed in vehicles, such as automobiles. As shown in FIG. 1, the lane deviation warning system 1 includes an in-vehicle network 10 using CAN (controller area network), an image sensor 12 and a buzzer 14.

The in-vehicle network 10 includes a yaw rate sensor 20 and a vehicle speed sensor 22. The yaw rate sensor 20 detects an angular velocity (i.e. yaw rate) in the turning direction of the vehicle. The vehicle speed sensor 22 detects a traveling speed (vehicle speed) of the vehicle.

The image sensor 12 includes a camera 30 and an image processing ECU 32 (hereinafter also just referred to as ECU 32) and a ROM 33. The ECU 32 (computer) performs processes described later by executing a predetermined program stored in the ROM 33 (storage medium). That is, the program is computer readable. The ECU 32 processes an image picked up by the camera 30 and outputs a control signal requesting an alarm to the buzzer 14. Further, the ECU 32 controls the exposure of the camera 30 according to the brightness of the picked-up image. The ECU 32 corresponds to the edge point extracting apparatus and the lane detection apparatus.

For example, the camera 30 is located, for example, at the center front of a vehicle to pick up a view ahead of the vehicle, including the road surface, at a predetermined time interval ( 1/15 second in the present embodiment). The picked up image of the road surface is outputted as data (hereinafter, the data may also be referred to as road surface image) to the ECU 32.

The camera 30 of the present embodiment is configured so as to pick up a road surface image by combining the three primary colors of light, i.e. color components of R (red), G (green) and B (blue). The road surface image includes pixels that express colors and brightness with the combinations of 256 levels of gradation of the respective colors R, G and B. Accordingly, the color components can be separately extracted from the road surface image. Examples of the camera 30 include well-known CCD image sensors or CMOS image sensors.

The ECU 32 is mainly configured by a well-known microcomputer including, although not shown, CPU, ROM, RAM, an input/output interface and a bus line connecting these components.

The ECU 32 performs lane deviation warning processing, which will be described later, according to an application program read from the ROM or various data stored in the RAM. In the lane deviation warning processing, every time a road surface image is received from the camera 30, the data of the image is stored in the RAM to perform lane detection based on the data.

The ECU 32 is connected to the in-vehicle network 10 to communicate with the yaw sensor 20 and the vehicle speed sensor 22 and obtain outputs of the sensors.

The ECU 32 is also connected to the buzzer 14 to output a control signal for requesting an alarm to the buzzer 14, when it is determined that an alarm should be raised, in the lane deviation warning processing described later.

Upon reception of the control signal from the ECU 32, the buzzer 14 audibly raises an alarm inside the vehicle.

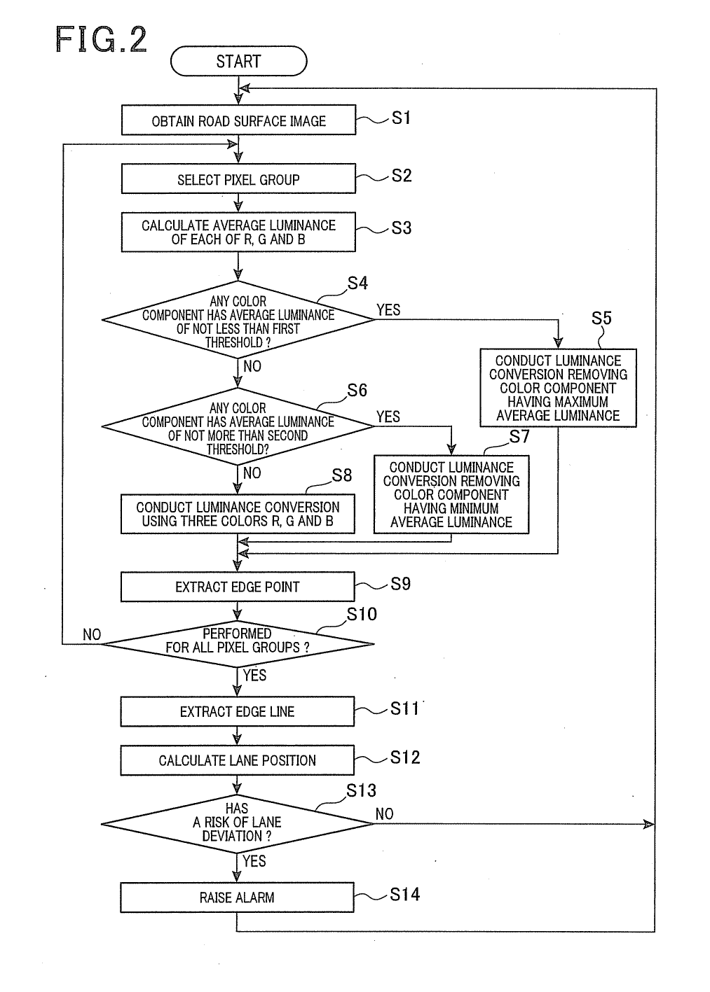

Referring now to FIG. 2, hereinafter is described the lane deviation warning processing performed by the ECU 32. FIG. 2 is a flow diagram illustrating the lane deviation warning processing. The lane deviation warning processing is started when an accessory switch of the vehicle is turned on to activate the image sensor 12, and repeatedly executed until the accessory switch is turned off to shut down the image sensor 12.

In step S1 of the lane deviation warning processing, data of a road surface image is obtained first from the camera 30.

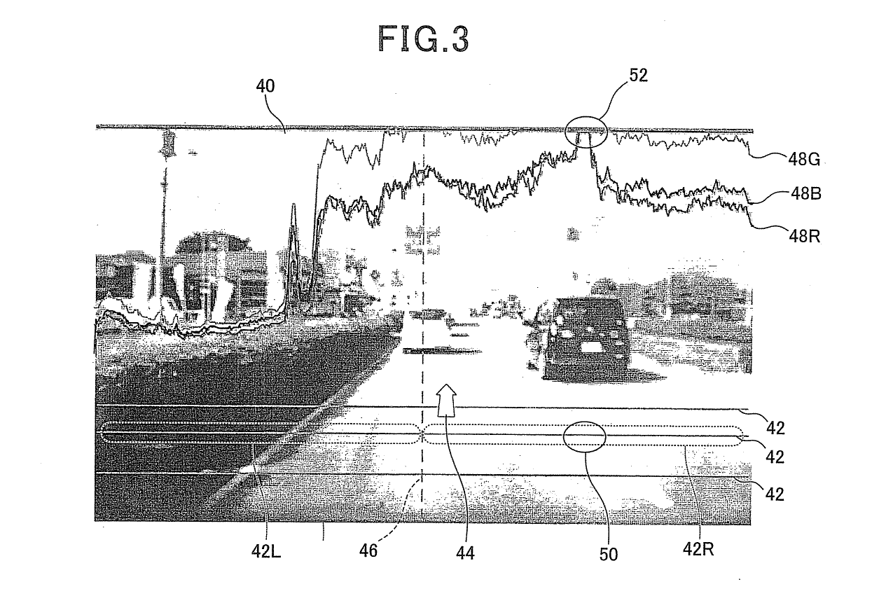

Then, in step S2, the ECU 32 sets a plurality of inspection lines 42, each of which is a row of pixels on the road surface image, and selects a group of pixels in the set inspection lines 42. FIG. 3 shows, as an example, a road surface image 40 picked up by the camera 30, and superimposed graphs indicating luminance (luminance graphs). The plurality of inspection lines 42 are arranged in the direction intersecting the traveling direction of the vehicle (the direction indicated by an arrow 44 in the figure). At the same time, the inspection lines 42 are vertically juxtaposed in the plane of the road surface image 40, with each of them being extended in the direction corresponding to the horizontal direction (the left-right direction in the road surface image 40).

The road surface image 40 also includes a reference line 46 extending in the vertical direction. The reference line 46 corresponds to a line along which the vehicle's center passes when the vehicle travels straight. In the road surface image 40, the reference line 46 defines an area of a left half and an area of a right half with respect to the region ahead of the vehicle. Accordingly, a left half and a right half are defined in each inspection line 42 by the reference line 46. The left and the right halves in each inspection line 42 correspond to pixel groups 42L and 42R, respectively.

In FIG. 3, the road surface image 40 is superimposed with luminance graphs of color components in the respective pixels of one inspection line 42. Specifically, in the pixels of one inspection line 42, luminance of the color component R is indicated by a graph 48R, luminance of the color component G is indicated by a graph 48G and luminance of the color component B is indicated by a graph 48B.

In the lane deviation warning processing, the ECU 32 extracts a point where luminance of pixels drastically changes, or where contrast is high, as an edge point. For example, the edge point corresponds to a border point between the road surface and a lane line. The edge point is extracted from each of the pixel groups 42R and 42L in a number of inspection lines 42 set in the road surface image 40.

As mentioned above, the plurality of inspection lines 42 are vertically juxtaposed in the road surface image 40. The edge points are detected from a number of pixel groups of the respective inspection lines 42. Thus, the edge points are extracted from a wide range of the road surface image 40, and based on the extracted edge points, the lane position is detected. FIG. 3 shows only a part of a number of inspection lines 42 (pixel groups 42L and 42R).

The processing of extracting edge points in the respective pixel groups is performed in steps S3 to S9 described later. In step S2, the ECU 32 selects one of the pixel groups in the road surface image 40, as a target of the edge-extracting processing. In this case, the pixel group to be selected should be the one which has not yet been selected (a pixel group for which the processing of steps S3 to S9 has not yet been performed).

Next, in step S3, an average luminance is calculated for each of the color components of the pixel group selected in step S2. Specifically, in step S3, an average luminance of all of the pixels in the selected pixel group is calculated for each of the color components R, G and B.

Next, in step S4, it is determined whether or not the average luminance calculated in step S3 is equal to or higher than a first threshold. If the average luminance is equal to or higher than the first threshold (YES in step S4), control proceeds to step S5. In step S5, luminance conversion is conducted for the color components after removing the color component having the maximum average luminance. For example, let us suppose that, of the color components R, G and B, the color component R alone has an average luminance equal to or higher than the first threshold. In this case, the ECU 32 obtains luminance data by calculating an average luminance of the color components G and B for each of the pixels in the pixel group.

In the following description, when a term luminance conversion is used, the term refers to the processing of obtaining luminance data by calculating an average luminance of the color components for each of the pixels in a pixel group.

Steps 4 and 5 are described in detail. The description below is provided based on the case where the pixel groups 42L and 42R are concurrently processed. Part of the inspection line 42, which includes the pixel groups 42L and 42R to be processed as shown in FIG. 3, lies in the area of the left half with respect to the reference line 46. The left half includes a roadside hedge and a shadow cast by the hedge. Accordingly, in all of the graphs 48R, 48G and 48B, the parts corresponding to the hedge and shadow exhibit low luminance.

On the other hand, the area of the right half with respect to the reference line 46 exhibits high luminance in general because the exposure of the camera 30 has been adjusted based on the shadow part in the left half. In particular, the graph 48G of the color component G exhibits higher luminance than the luminance graphs of other color components and shows saturation (maximum level of gradation) over the wide range.

Therefore, in the pixel group 42R in the right half, the luminance is not varied in an area 52 of the graph 48G, which area corresponds to an area 50 that indicates a white line on the road surface.

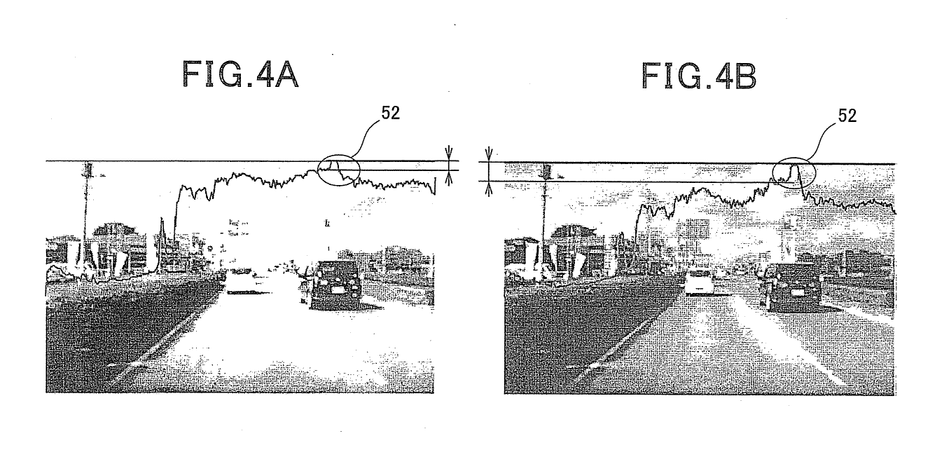

FIGS. 4A and 4B show road surface images and superimposed luminance graphs after luminance conversion. As shown in FIG. 4A, when luminance conversion is conducted based on the three color components R, G and B, the contrast in the area 52 is low being influenced by the graph 48G having no variation. However, as shown in FIG. 4B, when luminance conversion is conducted for the two color components R and B, removing the color component G, the contrast in the area 52 is high compared to the contrast shown in FIG. 4A.

Thus, performing steps S4 and S5, the ECU 32 can obtain luminance data indicating high contrast from the pixel groups 42L and 42R of the road surface image 40.

If none of the color components has the average luminance equal to or higher than the first threshold (NO in step S4), control proceeds to step S6.

In step S6, it is determined whether or not there is any color component whose average luminance calculated in step S3 is equal to or lower than a predetermined second threshold. If any of the color components has an average luminance equal to or lower than the predetermined second threshold (YES in step S6), control proceeds to step S7. In step S7, luminance conversion is conducted for the color components, removing the one having a minimum average luminance.

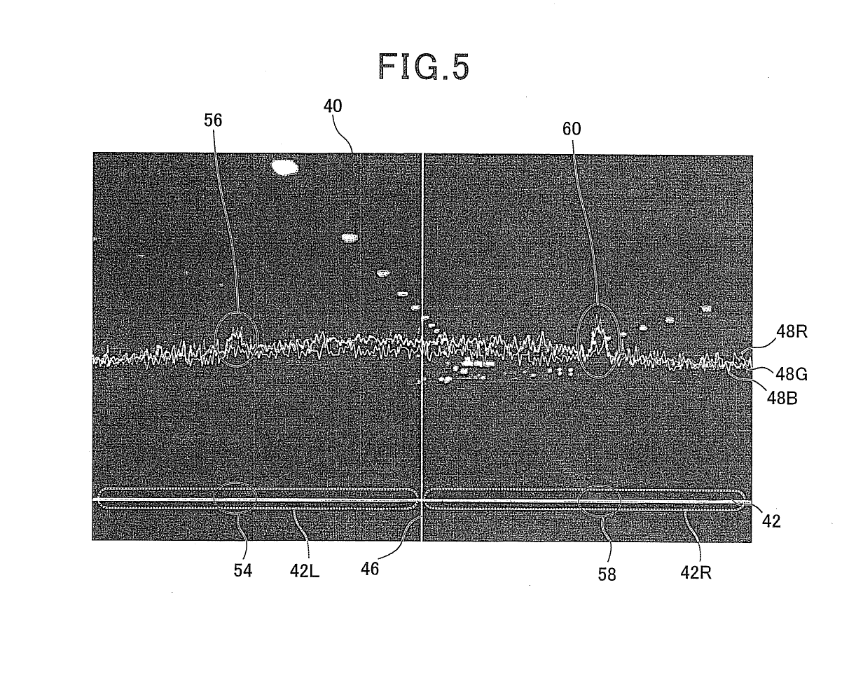

Steps S6 and S7 are described in detail. FIG. 5 shows the road surface image 40 picked up in a traveling situation different from that of FIG. 3 and also shows superimposed luminance graphs. The road surface image 40 shown in FIG. 5 indicates nighttime traveling. In FIG. 5, the components identical with those of FIG. 3 are given the same reference numerals. Also, an area 54 indicating a white line in the left pixel group 42L corresponds to an area 56 in the graphs, while an area 58 indicating a white line in the right pixel group 42R corresponds to an area 60 in the graphs. As can be seen from the figure, both of the graphs 48R and 48G show high contrast in the areas 56 and 60.

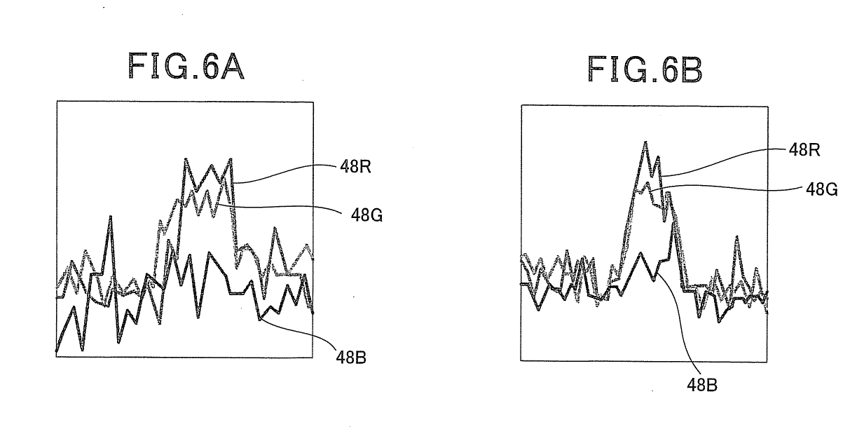

FIGS. 6A and 6B are enlarged views of the areas 56 and 60, respectively. In both of FIGS. 6A and 6B, the graph 48B shows low luminance.

This is because, when a white line on a road surface is lit by the headlights of the vehicle, the color component R exhibits high intensity in the road surface image, while the color component G originally exhibits rather high intensity, whereby the color component B exhibits relatively low luminance.

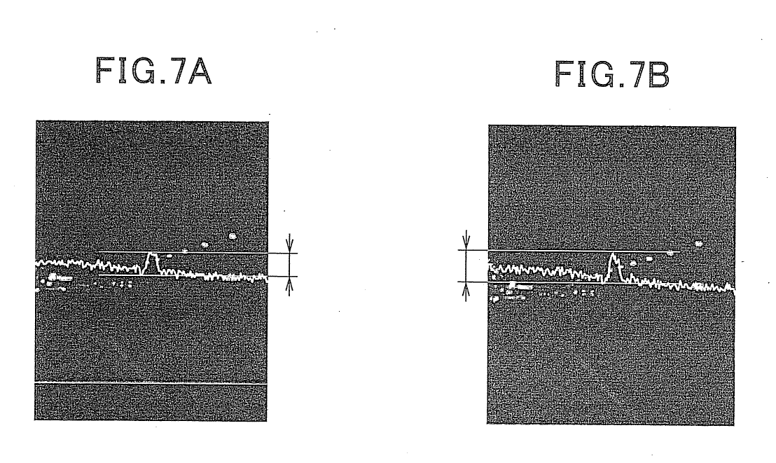

FIGS. 7A and 7B each show an image with a superimposed luminance graph after luminance conversion of the graphs 48R, 48G and 48B in the right half of FIG. 5. The luminance graph of FIG. 7A is based on luminance conversion of three color components R, G and B. The luminance graph of FIG. 7B is based on luminance conversion of two color components R and G, removing the color component B. As can be seen, the contrast in the area 60 is low in FIG. 7A being influenced by the graph 48B, while the contrast in the area 60 is high in FIG. 7B compared to FIG. 7A.

Thus, performing steps S6 and S7, the ECU 32 can extract a luminance graph exhibiting high contrast from the pixel groups 42L and 42R of the road surface image 40.

In step S6, if none of the color components has an average luminance equal to or higher than the predetermined value (NO in step S6), control proceeds to step S8. In step S8, luminance conversion is conducted for all of the three color components without removing any one of them because none of them has an average luminance equal to or higher than the first threshold or equal to or lower than the second threshold.

Next, in step S9, the luminance data resulting from the luminance conversion in step S5, S7 or S8 is differentiated to extract an edge point showing a maxim or minimum differential value. The extracted edge point is stored in the RAM, being correlated to the pixel group selected in step S2.

In step S10, it is determined whether or not the steps of extracting an edge point (steps S3 to S9) for all the pixel groups have been completed. If a negative determination is made (NO in step S10), control returns to step S2. If a positive determination is made (YES in step S10), control proceeds to step S11.

In step S11, an edge line is extracted. Specifically, all of the edge points extracted and stored in the RAM in step S9, i.e. all of the edge points based on the road surface image 40 obtained in step S1, are subjected to Hough transform to extract an edge line that passes through the maximum number of edge points.

Next, in step S12, the lane position is calculated. The lane position is calculated based on edge lines extracted from a predetermined number of latest road surface images (e.g., the latest three frames of the road surface images) that include the edge lines extracted in step S11. The reason why a plurality of number of road surface images are used is that use of the edge lines detected at a plurality of time points can enhance the accuracy of detecting the lane. However, if the processing load is desired to be reduced, a lane position may be calculated based on a single frame of the road surface image.

Then, a distance from the vehicle to the lane line is calculated based on the calculated lane position.

In step S13, it is determined whether or not the vehicle has a risk of deviating from the lane. Specifically, in step S13, a travel path of the vehicle is predicted based on the yaw rate obtained from the yaw rate sensor 20 and the vehicle speed obtained from the vehicle speed sensor 22. Next, a time that would be taken for the vehicle to deviate from the lane is calculated based on the lane position and the distance from the vehicle to the lane line calculated in step S12, and the travel path predicted at the present step.

If the calculated time that would be taken for lane deviation is equal to or more than a predetermined threshold (one second in the present embodiment), it is determined that no deviation will occur (NO in step S13) and control returns to step S1. If the calculated time is less than the threshold, it is determined that the vehicle has a risk of deviating from the lane (YES in step S13) and control proceeds to step S14. In step S14, a control signal for requesting an alarm is outputted to the buzzer 14. After that, control returns to step S1.

In the lane deviation warning system 1 according to the present embodiment, specific color components are removed when an edge point is extracted. The specific color components include one having a high possibility of having reached an upper limit luminance and thus exhibiting a low contrast, and one having a high possibility of having low luminance in general and thus exhibiting insufficient contrast. Thus, an edge point is extracted with high accuracy using the remaining color components exhibiting high contrast.

Further, in the lane deviation warning system 1 according to the present embodiment, a color component having a possibility of reducing the accuracy of extracting an edge point is removed to conduct luminance conversion by combining color components. Therefore, it is not necessary to conduct luminance conversion by appropriately combining color components and by using a combination that maximizes the contrast. Thus, the increase of the processing load is suppressed.

In addition, since the accuracy of extracting an edge point is enhanced, the accuracy of detecting a lane is also enhanced.

The processing performed in step S1 by the ECU 32 corresponds to the processing performed by an image obtaining means (unit). The processing of selecting a color component in steps S2, S3, S4 and S5 corresponds to the processing performed by a high luminance component selecting, means (unit). The processing of selecting a color component in steps S2, S3, S6 and S7 corresponds to the processing performed by a low luminance component selecting means (unit). The processing of conducting luminance conversion in steps S6 and S7 and the processing performed in step S9 correspond to the processing performed by an edge extracting means (unit). The processing performed in steps S11 and S12 corresponds to the processing performed by a lane detecting means (unit).

(Modifications)

An embodiment of the present invention has been described so far. However, the present invention is not limited to the embodiment described above, but may be implemented in various modes as far as the modes fall within the technical scope of the present invention.

For example, the above embodiment exemplifies a configuration in which the inspection line 42 is divided by the single reference line 46 to obtain two pixel groups 42L and 42R. Alternative to this, two or more reference lines may be provided to define three or more pixel groups in one inspection line. Alternatively, no reference line may be used to provide a single pixel group in one inspection line.

The above embodiment exemplifies a configuration in which a color component is determined to be removed when an edge line is extracted based on the average luminance of each of the color components in a pixel group. Alternatively, however, a color component may be determined to be removed in advance when predetermined conditions are met.

Let us take, as an example, the case where a camera system that would easily cause saturation of the color component G (green) is used in daytime when a road surface image exhibits high luminance. In this case, when the average luminance of all of the color components R (red), G and B (blue) in a pixel group is equal to or higher than a predetermined threshold, the color component G may be ensured to be removed. Thus, when it is apparent in advance that a certain color component would easily cause saturation, an average luminance is not required to be calculated for each of the remaining color components, thereby reducing the processing load.

Similarly, a color component may be removed, if the color component is unlikely to exhibit higher luminance than other color components in a road surface image picked up from the road surface which is lit by the headlights of the vehicle. For example, let us suppose that a road surface is lit by the headlights which are characteristic of raising the luminance of the color component B. In this case, in an area of the road surface image, which corresponds to the road surface lit by the headlights, either one of the color components R and G may be removed. In other words, if a color component exhibiting relatively low luminance is apparent from the characteristics of the headlights and the characteristics of the camera system, the color component in question may be ensured to be removed. Thus, the accuracy of extracting an edge point is enhanced without increasing the processing load.

In this case, when the color component unlikely to exhibit high luminance has an average luminance lower than a predetermined threshold, or when the average luminances of the three color components are lower than the predetermined threshold, the color component in question may be removed. Alternatively, when the luminance sensor or the clock furnished in the vehicle indicate nighttime, or when the headlights are lit, the color component in question may be removed.

The embodiment described above exemplifies a configuration in which a color component to be removed is determined based on the average luminances of the respective color components. However, alternative to the processing performed in step S3 of FIG. 2, the number of pixels having a luminance exceeding a predetermined threshold may be counted in a pixel group. Further, in this case, alternative to step S4, it may be determined whether or not any of the color components has such pixels in question, by the number not less than a predetermined threshold. Furthermore, if such color components in question are present, alternative to step S5, the color component having a maximum number of pixels with a luminance exceeding the predetermined threshold may be removed, followed by conducting luminance conversion. In this case, steps S6 and S7 are cancelled.

According to the configuration as set forth above, the color component having a high possibility of having reached an upper limit luminance and exhibiting low contrast is removed when an edge point is extracted. Thus, an edge point is extracted with high accuracy, while a high contrast is maintained. In this case, the processings of selecting a color component, which replace steps S2, S3 and S4 and replace step S5, correspond to the processing performed by the saturable component selecting means (unit).

The embodiment described above exemplifies a configuration in which the camera 30 picks up the road surface image composed of the three primary colors of R, G and B, and color information expressed by the combinations of the color components is used. Alternative to this, a signal format expressed by combining luminance signals with color-difference signals may be used. In this case, the luminance signals and the color-difference signals are required to be equivalently converted to the three primary colors of R, G and B.

Hereinafter, aspects of the above-described embodiments will be summarized.

As an aspect of the embodiment, in an edge point extracting apparatus, a road surface image is obtained which is picked up from a road surface ahead of a vehicle and from which a plurality of color components are separately extracted, a pixel group is extracted which includes a plurality of pixels arranged in a line on the road surface image, and a color component is selected from the plurality of color components extracted from the road surface image in the pixel group, the selected color component having the highest average luminance which is equal to or more than a predetermined threshold. The luminance here refers to a parameter indicating a level of gradation, i.e. gray scale, imparted to each of the color components in each pixel.

Then, an edge point in the pixel group is extracted by using a color component of the plurality of color components other than the selected color component. Specifically, an area having large luminance variation, i.e. having high contrast, is determined to be an edge point and extracted.

In the edge point extracting apparatus configured in this way, the color component having a high possibility of having reached an upper limit luminance and thus exhibiting a low contrast is removed when an edge point is extracted. Thus, an edge point is extracted with high accuracy using the remaining color components.

Also, the edge point extracting apparatus can remove the color component having a possibility of lowering the accuracy of extracting an edge point. This eliminates the necessity of calculating a contrast for each of a plurality of color-component combinations to obtain a combination exhibiting the maximum contrast, as disclosed in the patent document JP-2003-032669. Thus, increase of the processing load is suppressed. Further, since the accuracy of extracting an edge point is enhanced, the accuracy of detecting a lane is also enhanced.

The predetermined threshold mentioned above may be set to a value approximate to an upper limit value of luminance (e.g., 85% of the upper limit).

The reason why the contrast is lowered when luminance reaches an upper limit is as follows. In an apparatus of the conventional art, when an upper limit of luminance is reached in a color component A, the luminance no longer indicates a value equal to or higher than the upper limit (saturated). Therefore, the variation of luminance is small in the color component A. As a result, when the variation of luminance is measured using a plurality of color components including the color component A, the variation of luminance is small as a whole, being influenced by the small variation of luminance of the color component A. Thus, the accuracy of measuring an edge point is lowered.

As another aspect of the embodiment, in an edge point extracting apparatus, a road surface image is obtained which is picked up from a road surface ahead of a vehicle and from which a plurality of color components are separately extracted, a pixel group is extracted which includes a plurality of pixels arranged in a line on the road surface image, and a color component is selected from the plurality of color components extracted from the road surface image in the pixel group, the selected color component having a maximum number of pixels with a luminance exceeding a predetermined threshold, the maximum number being equal to or larger than a predetermined number. Then, an edge point is extracted by using a color component of the plurality of color components other than the selected color component.

Similar to the edge point extracting apparatus set forth, the edge point extracting apparatus configured in this way can accurately extract an edge point and thus suppress the increase of the processing load. Further, since the accuracy of extracting an edge point is enhanced, the accuracy of detecting a lane is also enhanced.

The predetermined threshold mentioned above may be set to a value approximate to an upper limit of luminance (e.g., 95% of the upper limit).

As another aspect of the embodiment, in an edge point extracting apparatus, a road surface image is obtained which is picked up from a road surface ahead of a vehicle and from which a plurality of color components are separately extracted, a pixel group is extracted which includes a plurality of pixels arranged in a line on the road surface image, and a color component is selected from the plurality of color components extracted from the road surface image in the pixel group, the selected color component having the lowest average luminance which is equal to or less than a predetermined threshold. Then, an edge point in the pixel group is extracted by using a color component of the plurality of color components other than the selected color component.

In the edge point extracting apparatus configured in this way, the color component having a high possibility of having low luminance as a whole and thus exhibiting insufficient contrast is removed. Thus, an edge point is extracted with high accuracy using the remaining color components exhibiting high contrast. Further, since the accuracy of extracting an edge point is enhanced, the accuracy of detecting a lane is also enhanced.

It should be appreciated that the predetermined threshold may be set to a value approximate to a lower limit of luminance.

In the edge point extracting apparatus, the pixel group is set in the substantial horizontal direction and in at least one of an area of a left half and an area of a right half with respect to a predetermined region ahead of the vehicle on the road surface image.

Camera systems in general have a function of controlling exposure according to the brightness of a captured image. The captured image may be partially dark and partially bright. If the exposure is controlled based on either of the dark part and the bright part of the captured image, some parts may be excessively dark, while some parts may be excessively bright.

In this regard, according to the edge point extracting apparatus set forth, a luminance for extracting an edge point is separately determined for the left and right halves of the road surface image. Thus, for example, when the road surface image in the right half is bright and that in the left half is dark, i.e. when the average luminance on the left and right halves as a whole is normal but one of the left and the right halves shows high luminance and the other one shows low luminance, the color components used for extracting an edge point can be appropriately selected for each of the left and the right halves.

A pixel group does not necessarily have to be set in either of the left and right halves of the road surface image. For example, the road surface image may be horizontally divided into three or more, and a pixel group may be set in any one of the divisions.

In the edge point extracting apparatus, the plurality of color components of the road surface image are three color components R, G and B (the three primary colors of light).

As another aspect of the embodiment, a lane detection apparatus includes any one of the above edge point extracting apparatuses, and a unit which detects a lane on the road surface based on the extracted edge point.

Although the specific means for detecting a lane from edge points is not limited, a line segment may be determined using Hough transform, for example, and a lane may be determined based on the line segment.

As another aspect of the embodiment, a computer readable storage medium is provided in which a lane detection program is recorded to allow a computer to function as: an image obtaining means which obtains a road surface image which is picked up from a road surface ahead of a vehicle and from which a plurality of color components are separately extracted; a high luminance component selecting means which extracts a pixel group including a plurality of pixels arranged in a line on the road surface image and selects a color component from the plurality of color components in the pixel group, the selected color component having the highest average luminance which is equal to or more than a predetermined threshold; an edge extracting means which extracts an edge point in the pixel group by using a color component of the plurality of color components other than the color component selected by the high luminance component selecting means; and a lane detecting means which detects a lane on the road surface based on the edge point extracted by the edge extracting means.

As another aspect of the embodiment, a computer readable storage medium is provided in which a lane detection program is recorded to allow a computer to function as: an image obtaining means which obtains a road surface image which is picked up from a road surface ahead of a vehicle and from which a plurality of color components are separately extracted; a saturable component selecting means which extracts a pixel group including a plurality of pixels arranged in a line on the road surface image and selects a color component from the plurality of color components in the pixel group, the selected color component having a maximum number of pixels with a luminance exceeding a predetermined threshold, the maximum number being equal to or larger than a predetermined number; an edge extracting means which extracts an edge point in the pixel group by using a color component of the plurality of color components other than the color component selected by the saturable component selecting means; and a lane detecting means which detects a lane on the road surface based on the edge point extracted by the edge extracting means.

As another aspect of the embodiment, a computer readable storage medium is provided in which a lane detection program is recorded to allow a computer to function as: an image obtaining means which obtains a road surface image which is picked up from a road surface ahead of a vehicle and from which a plurality of color components are separately extracted; a low luminance component selecting means which extracts a pixel group including a plurality of pixels arranged in a line on the road surface image and selects a color component from the plurality of color components in the pixel group, the selected color component having the lowest average luminance which is equal to or less than a predetermined threshold; an edge extracting means which extracts an edge point in the pixel group by using a color component of the plurality of color components other than the color component selected by the low luminance component selecting means; and a lane detecting means which detects a lane on the road surface based on the edge point extracted by the edge extracting means.

The computer system under the control of such a program may configure a part of the lane detection apparatus set forth.

The program mentioned above is composed of a string of sequenced commands which are suitable for the processing performed by the computer system. Thus, the program is stored in advance in a memory provided in the lane detection apparatus, or supplied to the users, via various storage media or communication lines, who use the lane detection apparatus.

What is claimed is:

1. An edge point extracting apparatus, comprising:
an image obtaining unit which obtains a road surface image which is picked up from a road surface ahead of a vehicle and from which a plurality of color components are separately extracted;
a high luminance component selecting unit which extracts a pixel group including a plurality of pixels arranged in a line on the road surface image and selects a color component from the plurality of color components in the pixel group, the selected color component having the highest average luminance which is equal to or more than a predetermined threshold; and
an edge extracting unit which extracts an edge point in the pixel group by using a color component of the plurality of color components other than the color component selected by the high luminance component selecting unit.

2. The edge point extracting apparatus according to claim 1, wherein the pixel group is in the substantial horizontal direction and in at least one of an area of a left half and an area of a right half with respect to a predetermined region ahead of the vehicle on the road surface image obtained by the image obtaining unit.

3. The edge point extracting apparatus according to claim 1, wherein the plurality of color components are three color components R, G and B.

4. A lane detection apparatus, comprising:
the edge point extracting apparatus according to claim 1; and
a lane detecting unit which detects a lane on the road surface based on the edge point extracted by the edge extracting unit.

5. An edge point extracting apparatus, comprising:
an image obtaining unit which obtains a road surface image which is picked up from a road surface ahead of a vehicle and from which a plurality of color components are separately extracted;
a saturable component selecting unit which extracts a pixel group including a plurality of pixels arranged in a line on the road surface image and selects a color component from the plurality of color components in the pixel group, the selected color component having a maximum number of pixels with a luminance exceeding a predetermined threshold, the maximum number being equal to or larger than a predetermined number; and
an edge extracting unit which extracts an edge point in the pixel group by using a color component of the plurality of color components other than the color component selected by the saturable component selecting unit.

6. The edge point extracting apparatus according to claim 5, wherein the pixel group is set in the substantial horizontal direction and in at least one of an area of a left half and an area of a right half with respect to a predetermined region ahead of the vehicle on the road surface image obtained by the image obtaining unit.

7. The edge point extracting apparatus according to claim 5, wherein the plurality of color components are three color components R, G and B.

8. A lane detection apparatus, comprising:
the edge point extracting apparatus according to claim 5; and
a lane detecting unit which detects a lane on the road surface based on the edge point extracted by the edge extracting unit.

9. An edge point extracting apparatus, comprising:
an image obtaining unit which obtains a road surface image which is picked up from a road surface ahead of a vehicle and from which a plurality of color components are separately extracted;
a low luminance component selecting unit which extracts a pixel group including a plurality of pixels arranged in a line on the road surface image and selects a color component from the plurality of color components in the pixel group, the selected color component having the lowest average luminance which is equal to or less than a predetermined threshold; and
an edge extracting unit which extracts an edge point in the pixel group by using a color component of the plurality of color components other than the color component selected by the low luminance component selecting unit.

10. The edge point extracting apparatus according to claim 9, wherein the pixel group is set in the substantial horizontal direction and in at least one of an area of a left half and an area of a right half with respect to a predetermined region ahead of the vehicle on the road surface image obtained by the image obtaining unit.

11. The edge point extracting apparatus according to claim 9, wherein the plurality of color components are three color components R, G and B.

12. A lane detection apparatus, comprising:
the edge point extracting apparatus according to claim 9; and
a lane detecting unit which detects a lane on the road surface based on the edge point extracted by the edge extracting unit.
